(19) United States
(12) Patent Application Publication
(10) Pub. No.: US 2009/0020526 A1
(43) Pub. Date: Jan. 22, 2009

(54) INDUCTION DEVICE COMPRISING MULTIPLE INDIVIDUAL COILS FOR INDUCTION HEATING PLATES

(75) Inventor: Alain Roux, Saint-Hilaire-Saint-Mesmin (FR)

Correspondence Address: YOUNG & THOMPSON, 209 Madison Street, Suite 500, ALEXANDRIA, VA, 22314, US

(73) Assignee: Fagorbrandt SAS, Rueil Malmaison (FR)

(21) Appl. No.: 12/159,207

(22) PCT Filed: Dec. 27, 2006
(86) PCT No.: PCT/FR2006/002888

§ 371 Date: Jun. 26, 2008

(30) Foreign Application Priority Data
Dec. 27, 2005 (FR) 05 13361

(51) Int. Cl. H05B 6/36

(52) U.S. Cl. 219/672

(57) ABSTRACT

An induction device for an induction heating plate (5), is adapted in such a way as to be arranged beneath a vitroceramic plate and includes at least first and second individual electroconductive windings (3A and 3B) which are arranged next to each other in a first plane. The device includes a magnetic conductive element (6) forming a coupling member which extends beneath the first individual winding (3A) and the second individual winding (3B) in such a way as to magnetically couple the first and second individual windings (3A and 3B). The invention can be especially used in an induction cooking surface.

The present invention relates to an induction device with multiple individual coils for induction heating plates.

It also relates to an induction hob equipped with at least one such induction device.

Generally speaking, the invention relates to an induction device used to heat cooking vessels by induction, in particular in a hob or range for domestic use.

An induction device conventionally comprises at least one individual coil made of an electrically conductive material.

Such an individual coil generally consists of a flat coil of copper wire intended to be fed, by means of an inverter, with a high-frequency current, generally between 20 kHz and 50 kHz.

The flow of this current in the individual coil has the effect of creating a magnetic field.

The flow of this magnetic field in a cooking vessel placed on a support above the inductor causes the flow of induced currents in the ferromagnetic base of this vessel. These induced currents have the effect of directly heating the cooking vessel.

It is known to associate the individual coil with one or more magnetic conductive elements extending below the coil and having the function of focusing the magnetic field generated by the individual coil onto a vessel to be heated, which is positioned above the induction device.

Induction heating plates are known that are equipped with inductors, each consisting of a single individual circular coil suited to the size of the heating plate.

Heating plates are also known that are equipped with inductors with multiple individual coils positioned side by side.

Such known configurations with multiple individual elements are not completely satisfactory. This is because the temperature distribution in the heated vessels is relatively inhomogeneous, particularly in the area situated between the individual coils in the case of circular coils and in the corner areas in the case of rectangular coils.

The present invention aims in particular to solve these problems.

To this end, the present invention relates to an induction device for an induction heating plate designed to be positioned under a glass-ceramic plate, comprising at least first and second individual coils with electrically conductive windings, positioned side by side in a first plane.

According to the invention, it comprises a magnetic conductive element forming coupling means extending below the first individual coil and below the second individual coil so as to magnetically couple said first and second individual coils.

This magnetic coupling thus obtained by the magnetic conductive element enables a mutual impedance between the first and second individual coils to be added, increasing accordingly the overall impedance of the inductor.

This increase enables the number of turns to be reduced, thus favoring a reduction in the quantity of copper and hence in the manufacturing cost of the individual coils. Such a reduction in material also enables the losses through heating of the coil to be reduced as the length of the copper wire is less.

Moreover, such an inductor device according to the invention enables the temperature distribution in the heated vessel to be improved thanks to additional induced currents at the location of the magnetic coupling thus produced between the two coils.

In practice, the magnetic conductive element is a one-piece element or is split into two parts separated by an airgap.

In this latter case, the airgap is less than or equal to 5 mm so as to allow coupling between the two coils by means of the two-part magnetic conductor element.

In practice, the larger the airgap, the less the magnetic coupling. Hence, the magnetic coupling is at a maximum with an airgap of approximately zero.

According to a practical feature of the invention, the magnetic conductive element extends in a direction coincident with an axis passing through the centers of said first and second coils.

Alternatively, the magnetic conductive element extends in a direction shifted relative to the axis passing through the centers of said first and second coils.

This arrangement allows the magnetic field generated to be shifted, for example toward the periphery of the coils, in order to generate induced currents over a larger area of the heating plate.

In one embodiment, the electrically conductive windings of the first and second individual coils are not parallel to each other.

The present invention is particularly advantageous in this particular case because, when the electrically conductive windings of an individual coil are not parallel to the electrically conductive windings of the neighboring individual coil, the natural magnetic coupling between these two individual coils is relatively poor.

Such is the case, in particular, with coils in disk form with spiral windings.

The first and second individual coils are preferably biased in opposite directions, which allows a maximum increase in the overall impedance of the system to be obtained.

For example, the first and second individual coils are connected in series.

In practice, the material of which the magnetic conductive elements consist is a ferrite, of chosen shape which may be square, rectangular, arranged in a rhombus or in a hexagon.

The present invention also relates to an induction hob, comprising at least one heating plate and a glass-ceramic plate.

According to the invention, this hob comprises an inductor device such as previously described associated with said heating plate.

Other features and advantages of the invention will become apparent in the light of the detailed description below and the drawings in which:

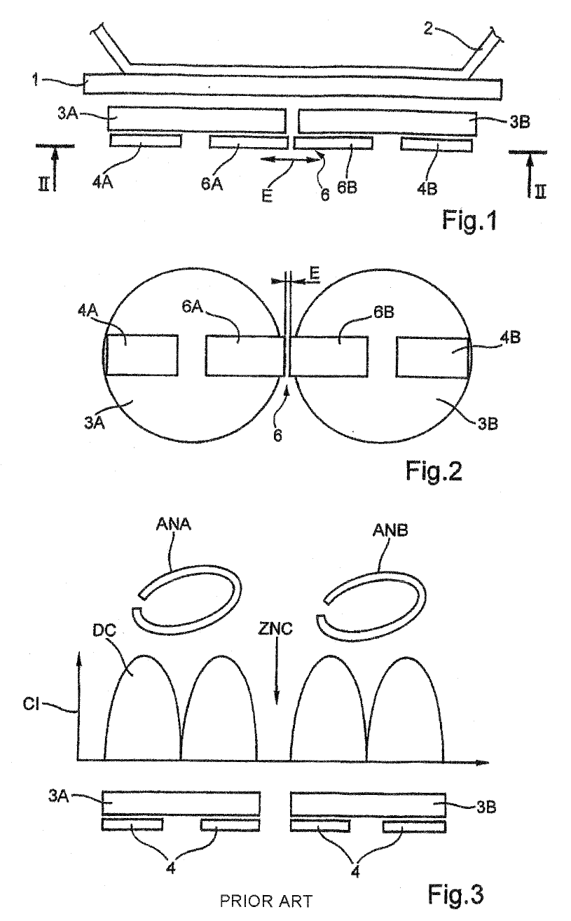

FIG. 1 is a cross-sectional view of a hob according to the invention;

FIG. 2 is a view from below in the plane II.II in FIG. 1 of an induction device according to one embodiment of the invention;

FIG. 3 represents the heating distribution for a heating plate of the prior art composed of two individual coils without magnetic coupling;

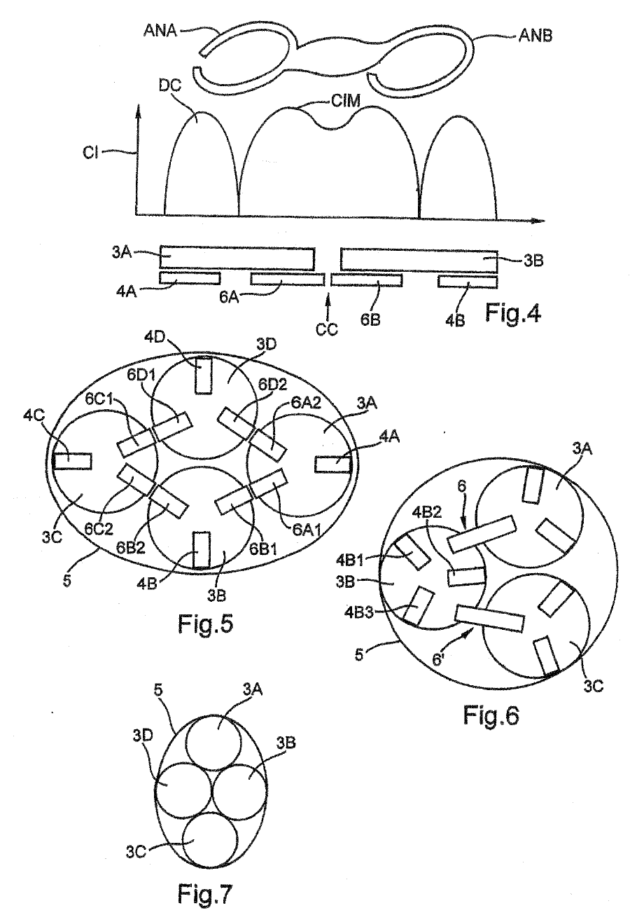

FIG. 4 schematically represents the heating distribution for a heating plate composed of two individual coils from FIG. 1 according to the invention;

FIG. 5 is an example of a heating plate with four individual coils which are magnetically coupled with an airgap, according to a second embodiment of the invention;

FIG. 6 is another example of a heating plate with three magnetically coupled coils without an airgap, according to a third embodiment of the invention;

FIG. 7 is an example of a heating plate equipped with circularly shaped individual coils;

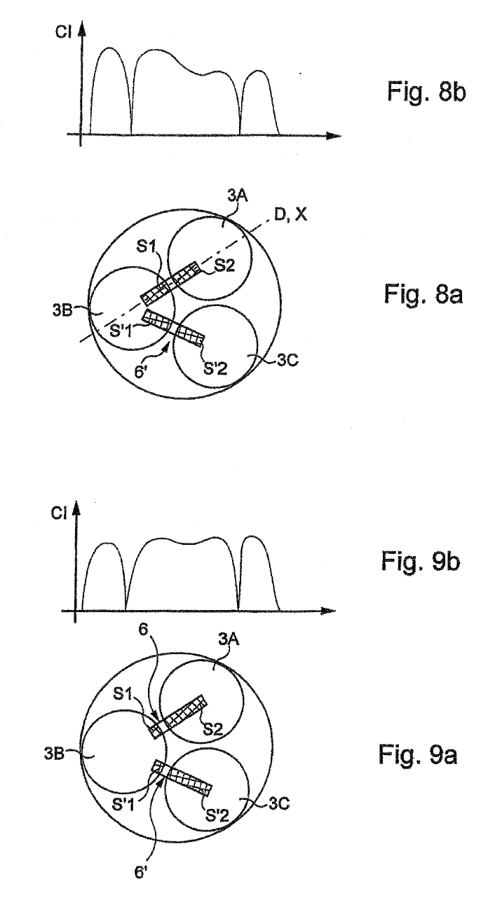

FIG. 8a is another example of a heating plate with three magnetically coupled coils without an airgap, according to a fourth embodiment of the invention;

FIG. 8b schematically represents the heating distribution for a heating plate composed of three individual coils from FIG. 8a;

FIG. 9a is another example of a plate with three magnetically coupled coils without an airgap, according to a fifth embodiment of the invention;

FIG. 9b schematically represents the heating distribution for a plate composed of three individual coils from FIG. 9a;

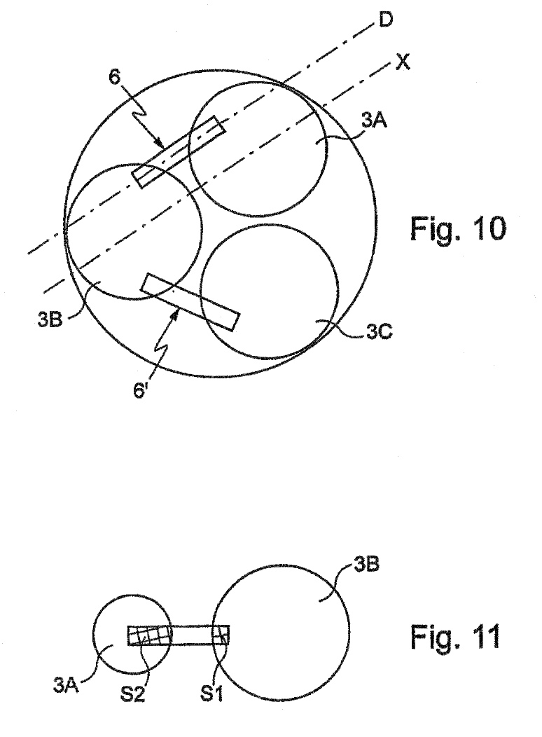

FIG. 10 is another example of a plate with three magnetically coupled coils without an airgap, according to a sixth embodiment of the invention; and

FIG. 11 is an example of a plate with two magnetically coupled coils without an airgap, according to a seventh embodiment of the invention.

An induction hob according to an embodiment of the present invention will first of all be described with reference to FIGS. 1 and 2.

Such a heating plate conventionally comprises a glass-ceramic plate 1 forming the support for a cooking vessel 2, below which one or more induction devices (here one in number) are located.

Such an induction cooking plate preferably comprises at least two heating plates, and preferably four heating plates, respectively associated with an inductor.

The inductor conventionally comprises at least two coils 3A, 3B each consisting of an electrically conductive winding.

Each individual coil 3A, 3B may consist of a flat spirallel winding of a stranded multiconductor cable of copper wires. Here (FIG. 2) each individual coil 3A, 3B is disk shaped.

The copper wires are electrically and individually insulated by a lacquer coating (not represented).

As is well illustrated in FIG. 3;, in known induction hobs magnetic conductive elements 4 are placed or bonded parallel to the plane of the individual coils 3A, 3B below each coil 3A, 3B.

In a known manner, the magnetic conductive elements 4 are ferrite rods positioned radially on the associated individual disk-shaped coil 3A, 3B.

By way of nonlimiting example, each individual coil 3A, 3B is associated with two ferrite rods 4 positioned along radii at 180° from each other.

These magnetic conductive elements 4 have the role of focusing the magnetic field generated by the associated coil 3A, 3B when a high-frequency current, from 20 to 50 kHz, is flowing.

The magnetic field is hence focused in the direction of the cooking vessel 2 to be heated.

The magnetic conductive elements 4 are hence positioned in a plane parallel to the plane of the coil 3A, 3B and below this coil while the induction device is placed underneath the glass-ceramic cooktop 1.

Referring to FIG. 7, the heating plate consists of several small individual coils 3 arranged so as best to cover the surface of the heating plate 5. These coils 3 may be circular in shape (FIG. 7). The heating plate thus formed may also correlatively be circular, for example when three individual coils are associated with the heating plate (FIG. 6), or elliptically shaped when two or four individual coils are associated with the heating plate (FIG. 2 or 5).

Reference will again be made to FIGS. 1 and 2.

According to the invention, the induction device furthermore comprises at least one magnetic conductive element 6 forming a means of coupling between the two coils 3A, 3B. This magnetic conductive element 6 extends both below the first individual coil 3A and below the second individual coil 3B in order to magnetically connect at least these two individual coils 3A, 3B positioned side by side.

This magnetic conductive element 6 is made of a material similar to that used for the magnetic conductive elements 4 previously described, for example made of a ferrite.

It enables a magnetic coupling between the coils, either with an airgap or without an airgap, to be ensured.

With reference to FIG. 1, an example of magnetic coupling with an airgap is represented in which the rod 6 is split into two parts 6A, 6B separated by an airgap E.

In this embodiment, one part of the rod 6A extends beyond the first coil 3A on one side, and the other part of the rod 6B extends beyond the second coil 3B on the other side. The two parts of the rod 6A, 6B are aligned with and opposite one another at a chosen distance. This distance is the airgap E.

The magnetic coupling between the coils 3A and 3B may be adjusted by choosing the value of the airgap E. With an airgap E of zero, the magnetic coupling is maximum. The larger the airgap E, the less the magnetic coupling. The Applicant has hence observed that a satisfactory magnetic coupling is obtained with an airgap value less than or equal to 5 mm, and preferably less than 4 mm. A magnetic coupling may be optimized with an airgap of between 1 and 2 mm.

The coils 3A and 3B thus magnetically coupled are advantageously biased in opposite directions so as to increase the overall impedance of the inductor.

When the coils 3A and 3B have a complex electrical impedance Z_{A} and Z_{B} respectively, the total impedance value when these two coils are connected in series is equal to Z_{A}+Z_{B} if the magnetic coupling is zero, for example due to an airgap E with a high value (FIG. 3). An absence of coupling between the magnetic conductive elements 4 positioned opposite each other is thus observed if the airgap is large, and for example around 10 mm.

According to the invention, with a nonzero magnetic coupling there is a supplementary mutual impedance Z_{AB} adding to the impedances of the individual coils alone. That is to say in total an electrical impedance equal to Z_{A}+Z_{B}+Z_{AB} is available.

By way of nonlimiting example, the Applicant has observed that for circular coils of around 100 mm, each of eighteen turns, with three ferrite rods per coil, the magnetic coupling is relatively satisfactory when the two parts of the magnetic conductive element 6A, 6B are separated from each other by an airgap E of less than 5 mm.

This observation was made with rectangular ferrite rods (42×23×4 mm) and a measurement current of 0.2 A at a frequency of 25 kHz. The measurements obtained are, for example, the following:
impedance of an individual coil alone: 3.32 ohm;
impedance of two coils without coupling: 6.64 ohm;
impedance of two coils with coupling and airgap E=4 mm: 6.68 ohm;
impedance of two coils with coupling and airgap E=2 mm: 6.71 ohm;
impedance of two coils with coupling and airgap E=1 mm: 6.77 ohm; and
impedance of two coils with coupling and airgap E=0 mm: 6.85 ohm.

With reference to FIG. 5, an example of a plate is represented, in which the coupling is said to be “with airgap”, with four coils individualized in 3A to 3B. In this example, the coils 3A and 3B are magnetically coupled by parts of the magnetic conductive element 6A1 and 6B1 that respectively extend beyond their associated coil 3A and 3B through to being very close to one another. Likewise for the coil 3B with the coil 3C, which are magnetically coupled by parts of the magnetic conductive element 6B2 and 6C2 that respectively extend beyond their associated coil 3B and 3C. Likewise again for the coil 3C with the coil 3D, which are magnetically coupled by means of parts of the magnetic conductive element 6C1 and 6D1 that respectively extend beyond their associated coil 3C and 3D. Finally, the coil 3D and the coil 3A are magnetically coupled by parts of the magnetic conductive element 6D2 and 6A2 that respectively extend beyond their associated coil 3D and 3A. It will also be observed that the inductor may comprise isolated magnetic conductive elements 4A, 4B, 4C and 4D that do not serve as a coupling means between the coils, but focus the magnetic field generated by the coils.

Although in this example the parts of the magnetic conductive elements 6Ai, 6Bi, 6Ci, 6Di, with i equal to 1 or 2, extend beyond the coils 3A, 3B, 3C, 3D, the Applicant has also observed that if the two individual coils are relatively close to each other (for example =5 mm) and if the airgap E has the same value as the distance between the two individual coils, the two parts of the magnetic conductive element 6A, 6B are able not to extend respectively beyond their associated individual coil 3A and 3B. Such a magnetic coupling, obtained solely with the help of an airgap of a chosen value (i.e. without extending the magnetic conductive elements beyond their associated coil) may in particular be employed when the electrically conductive elements of the coils 3 are not parallel to each other in the coupling area.

With reference to FIG. 6, a variant of the magnetic coupling, called “without airgap”, is represented. The magnetic coupling of FIG. 6 comes from a magnetic conductive element 6, 6′ made as one piece (i.e. not consisting of two parts separated from each other by the airgap E) which extends below the two coils to be coupled.

For example, the coil 3A is magnetically coupled with the coil 3B by means of the magnetic conductive element 6 which extends below the coil 3A and below the coil 3B.

In this embodiment where the induction device comprises a third coil 3C, the coils 3C and 3B are also magnetically coupled by means of a second magnetic conductive element 6′ without an airgap which extends below the coil 3B and below the coil 3C to produce the magnetic coupling between the coils 3C and 3B.

The position of the magnetic conductive element 6, 6′ in the case of the coupling without an airgap has a negligible effect on the mutual impedance. In these conditions, the magnetic conductive element 6, 6′ may be positioned symmetrically in the middle of the two coils or asymmetrically shifted toward one or the other (FIG. 6).

Symmetrically or asymmetrically positioning the magnetic conductive element 6, 6′ in the middle of the coils enables the magnetic field to be distributed more or less uniformly over the whole area of the heating plate.

As illustrated in FIG. 8a, in the case of a heating plate with three coils, two of the three coils 3A, 3C are biased in the same direction and the last coil 3B in the contrary direction. As the coupling is produced between two coils biased in opposite directions, the coil 3B with the unique bias is coupled to the two others. Hence, the coil 3B with the unique bias has two couplings and the two other coils 3A, 3C have a single coupling.

If the magnetic conductive elements forming coupling means 6, 6′ are arranged symmetrically, the strength of the magnetic field of the coil 3B with the unique bias is greater. Hence, the magnetic field is not uniform over the whole area of the heating plate (see FIG. 8b), producing over the heating plate points that are hotter than others.

In order to distribute the magnetic field better (FIG. 9b), the magnetic conductive elements 6, 6′ are arranged asymmetrically as illustrated in the embodiment of FIG. 9a. For example, the portion of surface S1 of the magnetic conductive element 6 covered by a first coil 3B is less than the portion of surface S2 of the magnetic conductive element 6 covered by a second coil 3A.

Likewise, the portion of surface S′1 of the magnetic conductive element 6′ covered by the first coil 3B is less than the portion of surface S′2 of the magnetic conductive element 6′ covered by a third coil 3C.

This arrangement is particularly suited to making the magnetic field uniform when the first coil 3B, with unique bias, is coupled twice, with each of the two other oppositely biased coils 3A, 3C respectively.

In the examples illustrated in FIGS. 8a and 9a, the magnetic conductive elements 6, 6′ forming coupling means extend in a direction D coincident with an axis X passing through the centers of the coils thus coupled 3A, 3B and 3C, 3B.

Alternatively, FIG. 10 illustrates another embodiment in which the magnetic conductive elements 6, 6′ extend in a direction D shifted relative to the axis X passing through the centers of the coils thus coupled 3A, 3B and 3C, 3B.

In this way, the magnetic field is enlarged at the periphery of the coils 3A, 3B, 3C and consequently currents are induced over a larger area of the heating plate, and therefore over a larger area of the vessel to be heated.

Illustrated in FIG. 11 is another embodiment of an induction device of the invention in which two coils 3A, 3B of different size are used. For example, the dimensions of a first coil 3B are greater than the dimensions of the second coil 3A. For example, the diameter of the first coil 3B is greater than the diameter of the second coil 3A.

In order also to make the magnetic field generated uniform, the magnetic conductive element forming a coupling means 6 is positioned asymmetrically below the two coils. For example, the portion of surface S1 covered by the first coil 3B of greater dimensions is less than the portion of surface S2 covered by the second coil 3A.

More generally, the Applicant has observed that the positioning and/or the dimensions, in particular the length and/or the width of the magnetic conductive element 6 in the case of coupling with or without an airgap, determine the value of said coupling.

In practice, the larger the length and/or the width of the magnetic conductive element 6, the better the magnetic coupling and the higher the mutual impedance.

The shape of the magnetic conductive elements 6, 6′ may also be varied: square, rectangular, arranged in a rhombus or in a hexagon.

For example, the Applicant has observed that the maximum coupling (with elements of the same dimensions as those of the coupling with an airgap) corresponds to an impedance of 6.82 ohms with a magnetic conductive element of 84 mm (42×2).

An impedance of 6.81 ohms corresponds to a 79 mm ferrite, an impedance of 6.61 ohms corresponds to a 64 mm ferrite and an impedance of 6.47 ohms corresponds to a 54 mm ferrite. In other words, the greater the length of the ferrite in the coupling area, the better the coupling.

The present invention provides numerous advantages in relation to the prior art in which the individual coils 3 are not magnetically coupled by magnetic conductive elements 4.

Firstly, the overall impedance of the heating plate formed from several magnetically coupled coils according to the invention is increased, which enables the number of turns and hence the quantity of copper for an equivalent configuration without coupling to be reduced. The impedance of a coil is proportional to the number of turns. For example, for a system with three identical coils having an overall impedance Z_{G}, each independent coil has an individual impedance Z_{A}=Z_{B}=Z_{C}=Z_{G}/3 in the case where the electrically conductive elements are not parallel to each other, according to the prior art.

According to the invention, in the case where there is a magnetic coupling Z_{AB} between the coils 3A and 3B and a magnetic coupling Z_{BC} between the coils 3B and 3C, the overall impedance Z_{G} is then equal to Z_{G}=Z_{A}+Z_{B}+Z_{C}+Z_{AB}+Z_{BC}, that is Z_{A}=Z_{B}=Z_{C}=(Z−Z_{AB}−Z_{BC})/3. It results from this that the overall impedance Z_{G} is lower in the presence of a magnetic coupling according to the invention in relation to an overall impedance Z_{G} in the absence of magnetic coupling between the individual coils. The lower quantity of copper consequently enables a saving on the cost of the heating plate.

The reduction in the number of turns also creates a reduction in the length of copper wire, which consequently reduces the losses through heating of the coils. This advantage allows the heating plate to be operated longer due to taking longer to reach the maximum temperature. As a variant, such a reduction allows reduction in the cross section of the copper wire for working at constant loss. This advantage enables the heating plate to be operated at higher power.

The coupling between the coils according to the invention (with or without an airgap) furthermore enables improvement of the temperature distribution in the heated vessel, as illustrated in a comparative manner with reference to FIGS. 3 and 4. This is because the heating of the vessel is linked to the induced currents CI in the depth of the base of said vessel. The circular coils 3A, 3B induce circular currents, the maximum density DC of which is situated close to the half-radius of the coils. This generates heating in the form of a ring AN. When the coils 3A and 3B are not magnetically coupled, for example due to an airgap of high value (FIG. 3), the area separating said coils corresponds to a relatively unheated area ZNC. With a magnetic coupling according to the invention (in FIG. 4), the magnetic coupling between the elements 6A and 6B results in a coupling with an airgap of a chosen value to obtain the desired magnetic coupling between the two individual coils 3A and 3B; additional induced currents CIM are furthermore generated at the point of the magnetic coupling CC, which accordingly increases the heating surface.

The adjustment of the value of the magnetic coupling with or without an airgap respectively obtained by regulating the airgap and/or the dimensions and/or the position of the magnetic conductive element determines the value of the additional induced currents CIM in order to obtain an optimum distribution of the temperature in the heated vessels.

1. Induction device for an induction heating plate designed to be positioned under a glass-ceramic plate (1), comprising at least first and second individual coils (3A and 3B) with electrically conductive windings, positioned side by side in a first plane, characterized in that it comprises a magnetic conductive element (6) forming coupling means extending below the first individual coil (3A) and below the second individual coil (3B) so as to magnetically couple said first and second individual coils (3A and 3B).

2. Device according to claim 1, characterized in that the magnetic conductive element (6) is a one-piece element.

3. Device according to claim 1, characterized in that the magnetic conductive element (6) is split into two parts (6A, 6B) separated by an airgap (E).

4. Device according to claim 3, characterized in that the airgap (E) is less than or equal to 5 mm.

5. Device according to claim 3, characterized in that the two parts (6A and 6B) of the magnetic conductive element extend beyond the first and second individual coils (3A and 3B) respectively.

6. Device according to claim 1, characterized in that the magnetic conductive element (6; 6′) extends in a direction (D) coincident with an axis (X) passing through the centers of said first and second coils (3A, 3B; 3B, 3C).

7. Device according to claim 1, characterized in that the magnetic conductive element (6; 6′) extends in a direction (D) shifted relative to the axis (X) passing through the centers of said first and second coils (3A, 3B; 3B, 3C).

8. Device according to claim 1, characterized in that the portion of surface (S1; S1′) of the magnetic conductive element (6; 6′) covered by the first coil (3B) is less than the portion of surface (S2; S2′) of the magnetic conductive element (6; 6′) covered by the second coil (3A; 3C).

9. Device according to claim 1, characterized in that the dimensions of the first coil (3B) are greater than the dimensions of the second coil (3A).

10. Device according to claim 1, characterized in that it comprises at least a third coil (3C) and at least a second magnetic conductive element (6′) forming coupling means extending below the first coil (3B) and below the third coil (3C).

11. Device according to claim 1, characterized in that the electrically conductive windings of the individual coils (3A, 3B) are not parallel to each other.

12. Device according to claim 1, characterized in that the first and second individual coils (3A, 3B) are biased in opposite directions.

13. Device according to claim 1, characterized in that the first and second individual coils (3A, 3B) are connected in series.

14. Device according to claim 1, characterized in that the first and second individual coils (3A, 3B) each extend in a disk.

15. Device according to claim 1, characterized in that the material of the magnetic conductive element(s) (6, 6′) forming coupling means is a ferrite.

16. Induction hob comprising at least one heating plate (5) and a glass-ceramic plate (1), characterized in that it comprises an induction device claim 1 associated with said heating plate.

17. Device according to claim 4, characterized in that the two parts (6A and 6B) of the magnetic conductive element extend beyond the first and second individual coils (3A and 3B) respectively.
